(19) United States
(12) Patent Application Publication
(10) Pub. No.: US 2021/0229692 A1
(43) Pub. Date: Jul. 29, 2021

(54) Tailgating Detection and Notification Assembly

(71) Applicant: Michael Johnson, Manvel, TX (US)

(72) Inventor: Michael Johnson, Manvel, TX (US)

(21) Appl. No.: 16/776,048

(22) Filed: Jan. 29, 2020

(51) Int. Cl. B60W 50/14; B60Q 1/30; B60Q 1/52; B60W 50/00

(52) U.S. Cl. CPC B60W 50/14; B60Q 1/30; B60W 2050/146; B60W 2050/0002; B60Q 1/525

(57) ABSTRACT

A tailgating detection and notification assembly for reducing vehicle collisions includes a sensor and a notification module that are mountable to a vehicle. The sensor is proximity type and can detect entry of a following vehicle into a tailgating range. The notification module comprises a microprocessor and a display. The sensor and the notification module are mountable so that the sensor and the display are rear facing. The microprocessor is operationally coupled to the sensor and the display and thus is positioned to selectively actuate the display upon receipt of a signal from the sensor when the following vehicle enters the tailgating range. The display selectively presents a tailgating notification to a driver of the following vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to detection and notification assemblies and more particularly pertains to a new detection and notification assembly for reducing vehicle collisions.

### (2) Description of Related Art Including Information Disclosed Under 37 CFR 1.97 and 1.98

The prior art relates to detection and notification assemblies. Prior art detection and notification assemblies generally comprise detectors, transmitters, and receivers and require one of each of these elements to be positioned both on a vehicle and a trailing vehicle to detect a tailgating event.

### BRIEF SUMMARY OF THE INVENTION

An embodiment of the disclosure meets the needs presented above by generally comprising a sensor and a notification module that are mountable to a vehicle. The sensor is proximity type and can detect entry of a following vehicle into a tailgating range. The notification module comprises a microprocessor and a display. The sensor and the notification module are mountable so that the sensor and the display are rear facing. The microprocessor is operationally coupled to the sensor and the display and thus is positioned to selectively actuate the display upon receipt of a signal from the sensor when the following vehicle enters the tailgating range. The display selectively presents a tailgating notification to a driver of the following vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a tailgating detection and notification assembly according to an embodiment of the disclosure.

FIG. 2 is a front view of an embodiment of the disclosure.

FIG. 3 is a rear view of an embodiment of the disclosure.

FIG. 4 is a side view of an embodiment of the disclosure.

FIG. 5 is an in-use view of an embodiment of the disclosure.

FIG. 6 is an in-use view of an embodiment of the disclosure.

### DETAILED DESCRIPTION OF THE INVENTION

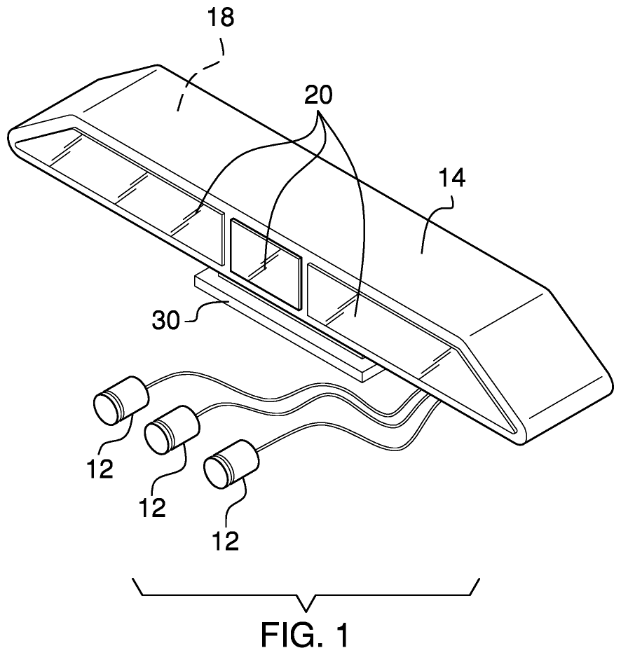

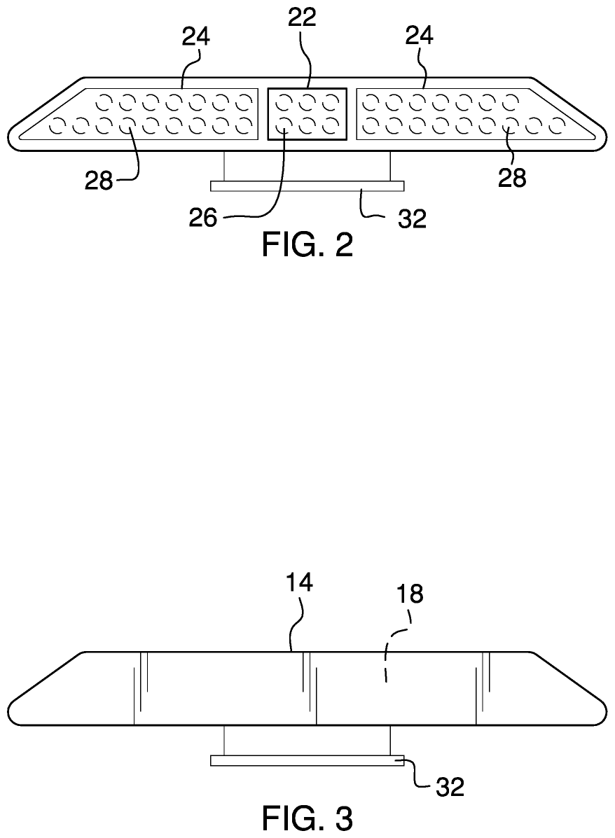

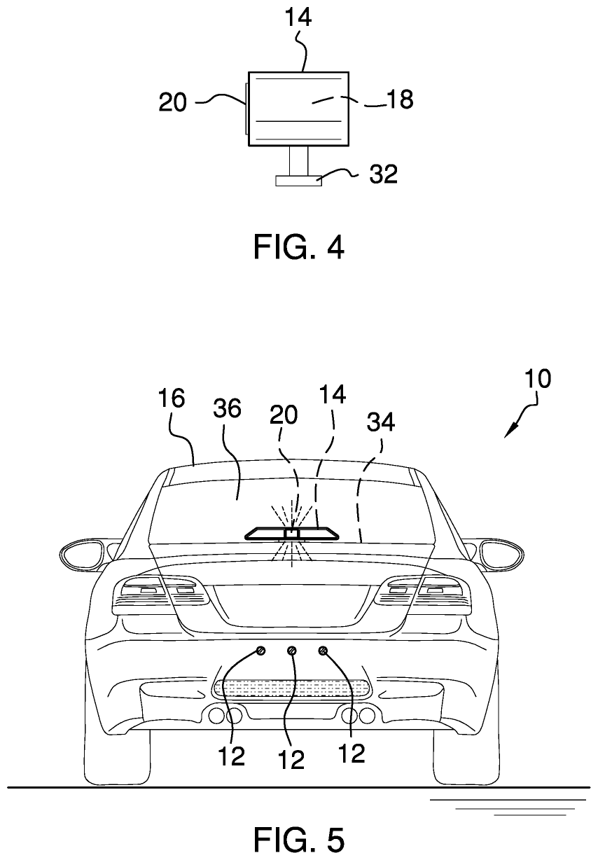

With reference now to the drawings, and in particular to FIGS. 1 through 6 thereof, a new detection and notification assembly embodying the principles and concepts of an embodiment of the disclosure and generally designated by the reference numeral 10 will be described.

As best illustrated in FIGS. 1 through 6, the tailgating detection and notification assembly 10 generally comprises a sensor 12 and a notification module 14 that are configured to be mountable to a vehicle 16. The present invention also anticipates the sensor 12 and the notification module 14 being integral to the vehicle 16. The sensor 12 is proximity type and thus is configured to detect entry of a following vehicle into a tailgating range. The notification module 14 comprises a microprocessor 18 and a display 20. The sensor 12 and the notification module 14 are mountable so that the sensor 12 and the display 20 are rear facing. The microprocessor 18 is operationally coupled to the sensor 12 and the display 20. The sensor 12 may be wired to the notification module 14, as shown in FIG. 1, although the present invention also anticipates the sensor 12 being wirelessly coupled to the notification module 14. The microprocessor 18 is positioned to selectively actuate the display 20 upon receipt of a signal from the sensor 12 that the following vehicle has entered the tailgating range. The display 20 is configured to selectively present a tailgating notification to a driver of the following vehicle.

The present invention anticipates the tailgating detection and notification assembly 10 being at least one of battery powered and operationally coupled to an electrical circuit of the vehicle 16.

The display 20 comprises a first unit 22 that is configured to emit yellow light and a second unit 24 that is configured to emit red light. The microprocessor 18 is positioned to selectively actuate the first unit 22 when the following vehicle enters the tailgating range with the emitted yellow light providing an initial warning to the driver of the following vehicle. The microprocessor 18 is positioned to selectively actuate the second unit 24, as a second and more forceful warning to the driver of the following vehicle, when the following vehicle remains in the tailgating range for a preset length of time.

The first unit 22 comprises a yellow light emitting diode 26, and the second unit 24 comprises a red light emitting diode 28. The first unit 22 is configured for intermittent illumination, thus providing a flashing effect. The present invention also anticipates the second unit 24 being configured for intermittent illumination.

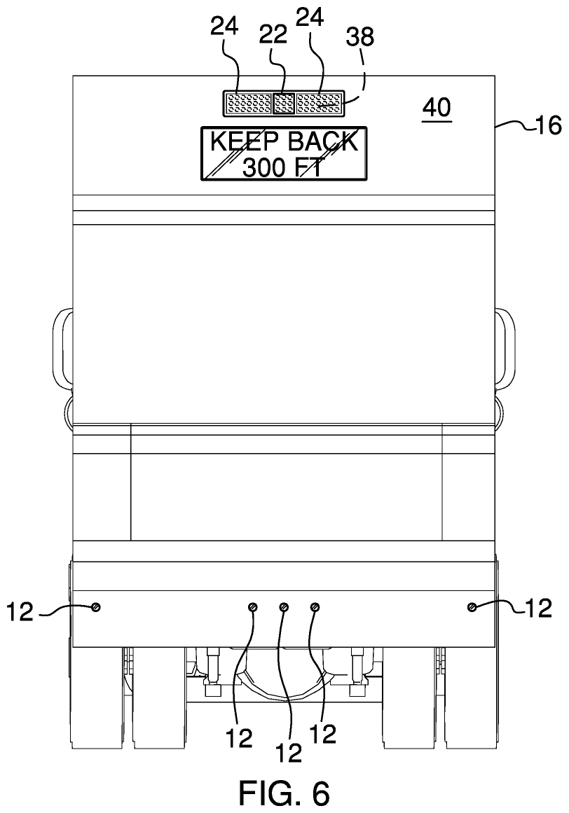

A coupler 30 that is engaged to the notification module 14 is configured to engage the vehicle 16 to couple the notification module 14 to the vehicle 16. The coupler 30 comprise at least one of a base 32 and a fastener 38. The base is configured to support the notification module 14 on an interior surface 34 of the vehicle 16 proximate to a rear window 36 of the vehicle 16, as shown in FIG. 5. The fastener 38 is configured to engage an exterior surface 40 of the vehicle 16, as shown in FIG. 6, to couple the notification module 14 to the vehicle.

The present invention also anticipates the notification module 14 being operationally coupled to an electronic control unit (not shown) of the vehicle 16. Programming code that would be positioned on at least one of the microprocessor 18 and the electronic control unit would enable real time adjustment of the tailgating range and the preset length of time based on the speed of the vehicle 16.

In use, the sensor 12 and the notification module 14 are mounted to a vehicle 16 so that the sensor 12 and the display 20 are rear facing. When the following vehicle enters the tailgating range, the microprocessor 18 actuates the first unit 22 to provide an initial warning to the driver of the following vehicle. Should the following vehicle remain in the tailgating range for the preset length of time, the microprocessor 18 actuates the second unit 24 as a second and more forceful warning to the driver of the following vehicle.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A tailgating detection and notification assembly comprising:
a sensor configured to be mountable to a vehicle such that the sensor is rear facing, the sensor being proximity type wherein the sensor is configured for detecting entry of a following vehicle into a tailgating range; and
a notification module comprising a microprocessor and a display, the notification module being configured to be mountable to the vehicle such that the display is rear facing, the microprocessor being operationally coupled to the sensor and the display such that the microprocessor is positioned for selectively actuating the display upon receipt of a signal from the sensor when the following vehicle enters into the tailgating range wherein the display is configured for selectively presenting a tailgating notification to a driver of the following vehicle.

2. The tailgating detection and notification assembly of claim 1, wherein the display comprises a first unit configured to emit yellow light and a second unit configured to emit red light such that the microprocessor is positioned for selectively actuating the first unit when the following vehicle enters into the tailgating range and for selectively actuating the second unit when the following vehicle remains in within the tailgating range for a preset length of time.

3. The tailgating detection and notification assembly of claim 2, wherein the first unit is configured for intermittent illumination.

4. The tailgating detection and notification assembly of claim 2, wherein the first unit comprises a yellow light emitting diode.

5. The tailgating detection and notification assembly of claim 2, wherein the second unit comprises a red light emitting diode.

6. The tailgating detection and notification assembly of claim 1, further including a coupler engaged to the notification module and configured for engaging the vehicle to couple the notification module to the vehicle.

7. The tailgating detection and notification assembly of claim 6, wherein the coupler comprises at least one of a base configured for supporting the notification module on an interior surface of the vehicle proximate to a rear window of the vehicle and a fastener configured for engaging an exterior surface of the vehicle.

8. A tailgating detection and notification assembly comprising:
a sensor configured to be mountable to a vehicle such that the sensor is rear facing, the sensor being proximity type wherein the sensor is configured for detecting entry of a following vehicle into a tailgating range;
a notification module comprising a microprocessor and a display, the notification module being configured to be mountable to the vehicle such that the display is rear facing, the microprocessor being operationally coupled to the sensor and the display such that the microprocessor is positioned for selectively actuating the display upon receipt of a signal from the sensor when the following vehicle enters into the tailgating range wherein the display is configured for selectively presenting a tailgating notification to a driver of the following vehicle, the display comprising a first unit configured for emitting yellow light and a second unit configured for emitting red light such that the microprocessor is positioned for selectively actuating the first unit when the following vehicle enters into the tailgating range and for selectively actuating the second unit when the following vehicle remains in within the tailgating range for a preset length of time, the first unit comprising a yellow light emitting diode, the second unit comprising a red light emitting diode, the first unit being configured for intermittent illumination; and
a coupler engaging the notification module and configured for engaging the vehicle for coupling the notification module to the vehicle, the coupler comprising at least one of a base configured for supporting the notification module on an interior surface of the vehicle proximate to a rear window of the vehicle and a fastener configured for engaging an exterior surface of the vehicle.

9. A tailgating detection and notification assembly and vehicle combination comprising:
a vehicle;
a sensor selectively mountable to the vehicle such that the sensor is rear facing, the sensor being proximity type wherein the sensor is configured for detecting entry of a following vehicle into a tailgating range; and
a notification module comprising a microprocessor and a display, the notification module being selectively mountable to the vehicle such that the display is rear facing, the microprocessor being operationally coupled to the sensor and the display such that the microprocessor is positioned for selectively actuating the display upon receipt of a signal from the sensor when the following vehicle enters into the tailgating range wherein the display is configured for selectively presenting a tailgating notification to a driver of the following vehicle.

10. The tailgating detection and notification assembly of claim 9, wherein the display comprises a first unit configured to emit yellow light and a second unit configured to emit red light such that the microprocessor is positioned for selectively actuating the first unit when the following vehicle enters into the tailgating range and for selectively actuating the second unit when the following vehicle remains in within the tailgating range for a preset length of time.

11. The tailgating detection and notification assembly and vehicle combination of claim 10, wherein the first unit is configured for intermittent illumination.

12. The tailgating detection and notification assembly and vehicle combination of claim 10, wherein the first unit comprises a yellow light emitting diode.

13. The tailgating detection and notification assembly and vehicle combination of claim 10, wherein the second unit comprises a red light emitting diode.

14. The tailgating detection and notification assembly and vehicle combination of claim 9, further including a coupler engaged to the notification module and configured for engaging the vehicle to couple the notification module to the vehicle.

15. The tailgating detection and notification assembly and vehicle combination of claim 14, wherein the coupler comprises at least one of a base configured for supporting the notification module on an interior surface of the vehicle proximate to a rear window of the vehicle and a fastener configured for engaging an exterior surface of the vehicle.
